(19) United States
(12) Patent Application Publication
(10) Pub. No.: US 2019/0203807 A1
(43) Pub. Date: Jul. 4, 2019

(54) POWER TRANSMISSION APPARATUS FOR VEHICLE

(71) Applicants: Hyundai Motor Company, Seoul (KR); Kia Motors Corporation, Seoul (KR)

(72) Inventor: Yeo Hyeon GWON, Yongin-si (KR)

(73) Assignees: Hyundai Motor Company, Seoul (KR); Kia Motors Corporation, Seoul (KR)

(21) Appl. No.: 16/136,670

(22) Filed: Sep. 20, 2018

(30) Foreign Application Priority Data
Dec. 28, 2017 (KR) 10-2017-0182959

(51) Int. Cl. F16H 3/00

(52) U.S. Cl. CPC F16H 3/006; F16H 2003/008; F16H 2200/2043; F16H 2200/0052

(57) ABSTRACT

A power transmission apparatus may include a first input shaft selectively connectable to an engine output shaft; a second input shaft selectively connectable to the engine output shaft; a first output shaft outputting a rotation power transmitted from the first input shaft and a rotation power transmitted from the second input shaft through a first output gear; a second output shaft outputting a rotation power transmitted from the first input shaft and a rotation power transmitted from the second input shaft through a second output gear; a third output shaft outputting a rotation power transmitted from the second input shaft through reverse idle gears rotatably disposed on the second output shaft through a third output gear; and six speed stage gear sets disposed on the first and second input shafts and the first to third output shafts, outputting the shifted rotation power through the first, second, and third output gears.

### CROSS-REFERENCE TO RELATED APPLICATION

The present application claims priority to Korean Patent Application No. 10-2017-0182959 filed on Dec. 28, 2017, the entire contents of which is incorporated herein for all purposes by this reference.

### BACKGROUND OF THE INVENTION

### Field of the Invention

The present invention relates to a power transmission apparatus configured for a vehicle applying a dual clutch. More particularly, the present invention relates to a power transmission apparatus configured for a vehicle for minimizing a whole length and improving a mountability by additionally disposing a separate shaft for realizing a reverse speed.

### Description of Related Art

Environmentally-friendly technique of vehicles is very important technique on which survival of future motor industry is dependent. Vehicle makers are focusing on development of environmentally-friendly vehicles to meet environment and fuel consumption regulations.

Some examples of future vehicle technique are an electric vehicle (EV) and a hybrid electric vehicle (HEV) that use electrical energy, and double clutch transmission (DCT) that improves efficiency and convenience.

The DCT may include two clutch devices and a gear train of a manual transmission. The DCT selectively transmits torque input from an engine to two input shafts through two clutches, changes the torque selectively transmitted to the two input shafts through the gear train, and outputs the changed torque.

The DCT is used to realize a compact transmission achieving a forward speed higher than a fifth forward speed. The DCT is used as an automated manual transmission that does not require a driver's manual manipulation by controlling two clutches and synchronizers by a controller.

Compared with an automatic transmission with planetary gear sets, the DCT has excellent power delivery efficiency, simplifies change and addition of components for achieving multiple gear stages, and improves fuel economy.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a power transmission apparatus configured for a vehicle for minimizing a whole length and improving a mountability by additionally disposing a reverse idle gear on a separate shaft.

A power transmission apparatus configured for a vehicle according to an exemplary embodiment of the present invention may include a first input shaft selectively connectable to an engine output shaft through a first clutch, wherein a plurality of input gears is fixedly disposed on the first input shaft; a second input shaft disposed on an external circumference side of the first input shaft without an interference and selectively connectable to the engine output shaft through a second clutch, wherein a plurality of input gears is fixedly disposed on the second input shaft; a first output shaft disposed to be parallel to the first and second input shafts and outputting a rotation power transmitted through two paths from the first input shaft and a rotation power transmitted through two paths from the second input shaft through a first output gear; a second output shaft disposed to be parallel to the first and second input shafts and outputting a rotation power transmitted through one path from the first input shaft and a rotation power transmitted through one path from the second input shaft through a second output gear; a third output shaft disposed to be parallel to the second output shaft and outputting a rotation power transmitted from the second input shaft through a plurality of reverse idle gears rotatably disposed on the second output shaft through a third output gear; and six speed stage gear sets dispersed and disposed on the first and second input shafts and the first, second, and third output shafts, shifting the rotation power of the engine according to a gear ratio of predetermined fixed speed stages, and outputting the shifted rotation power through the first, second, and third output gears.

The six speed stage gear sets may include a first speed stage gear set including a third input gear fixedly disposed on the first input shaft and a fifth speed gear rotatably disposed on the first output shaft and meshed with the third input gear; a second speed stage gear set including a second input gear fixedly disposed on the first input shaft and a first speed gear rotatably disposed on the second output shaft and meshed with the second input gear; a third speed stage gear set including a first input gear fixedly disposed on the first input shaft and a third speed gear rotatably disposed on the first output shaft and meshed with the first input gear; a fourth speed stage gear set including a fifth input gear fixedly disposed on the second input shaft, a sixth speed gear rotatably disposed on the first output shaft and meshed with the fifth input gear, and a fourth speed gear rotatably disposed on the second output shaft and meshed with the fifth input gear; a fifth speed stage gear set including a fourth input gear fixedly disposed on the second input shaft, a second speed gear rotatably disposed on the first output shaft and meshed with the fourth input gear, and a first reverse idle gear rotatably disposed on the second output shaft and meshed with the fourth input gear; and a sixth speed stage gear set including a second reverse idle gear rotatably disposed on the second output shaft and a third reverse idle gear fixedly disposed on the third output shaft and meshed with the second reverse idle gear.

The power transmission apparatus may further include a first synchronizer selectively connecting the fifth speed gear or the third speed gear to the first output shaft; a second synchronizer selectively connecting the sixth speed gear or the second speed gear to the first output shaft; a third synchronizer selectively connecting the first speed gear or the fourth speed gear to the second output shaft; and a fourth synchronizer selectively connecting the first reverse idle gear and the second reverse idle gear.

The power transmission apparatus may further include a differential apparatus including a final reduction gear meshed with the first, second, and third output gears.

A power transmission apparatus configured for a vehicle according to various exemplary embodiments of the present invention may include a first input shaft selectively connectable to an engine output shaft through a first clutch; a second input shaft disposed on an external circumference side of the first input shaft without an interference and selectively connectable to the engine output shaft through a second clutch; a first output shaft disposed to be parallel to the first and second input shafts and outputting a rotation power transmitted through a plurality of path from the first and second input shafts through a first output gear; a second output shaft disposed to be parallel to the first and second input shafts and outputting a rotation power transmitted through a plurality of paths from the first and second input shafts through a second output gear; a third output shaft disposed to be parallel to the second output shaft and outputting a rotation power transmitted through a plurality of reverse idle gears rotatably disposed on the second output shaft from the second input shaft through a third output gear; a first speed stage gear set including a third input gear fixedly disposed on the first input shaft and a fifth speed gear rotatably disposed on the first output shaft and meshed with the third input gear; a second speed stage gear set including a second input gear fixedly disposed on the first input shaft and a first speed gear rotatably disposed on the second output shaft and meshed with the second input gear; a third speed stage gear set including a first input gear fixedly disposed on the first input shaft and a third speed gear rotatably disposed on the first output shaft and meshed with the first input gear; a fourth speed stage gear set including a fifth input gear fixedly disposed on the second input shaft, a sixth speed gear rotatably disposed on the first output shaft and meshed with the fifth input gear, and a fourth speed gear rotatably disposed on the second output shaft and meshed with the fifth input gear; a fifth speed stage gear set including a fourth input gear fixedly disposed on the second input shaft, a second speed gear rotatably disposed on the first output shaft and meshed with the fourth input gear, and a first reverse idle gear rotatably disposed on the second output shaft and meshed with the fourth input gear; and a sixth speed stage gear set including a second reverse idle gear rotatably disposed on the second output shaft and a third reverse idle gear fixedly disposed on the third output shaft and meshed with the second reverse idle gear.

The power transmission apparatus may further include a first synchronizer selectively connecting the fifth speed gear or the third speed gear to the first output shaft; a second synchronizer selectively connecting the sixth speed gear or the second speed gear to the first output shaft; a third synchronizer selectively connecting the first speed gear or the fourth speed gear to the second output shaft; and a fourth synchronizer selectively connecting the first reverse idle gear and the second reverse idle gear.

The power transmission apparatus may further include a differential apparatus including a final reduction gear meshed with the first, second, and third output gears.

An exemplary embodiment of the present invention may minimize a vehicle length and improve a mountability by disposing the parts for realizing the reverse speed on the additional shaft.

Furthermore, effects which may be obtained or expected from exemplary embodiments of the present invention are directly or suggestively described in the following detailed description. That is, various effects expected from exemplary embodiments of the present invention will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a power transmission apparatus configured for a vehicle according to an exemplary embodiment of the present invention.

FIG. 2 is a shifting operation chart of a power transmission apparatus configured for a vehicle according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of Exemplary embodiments of the present application will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

The drawings and description are to be regarded as illustrative in nature and not restrictive, and like reference numerals designate like elements throughout the specification.

In the following description, dividing names of components into first, second and the like is to divide the names because the names of the components are the same as each other and an order thereof is not particularly limited.

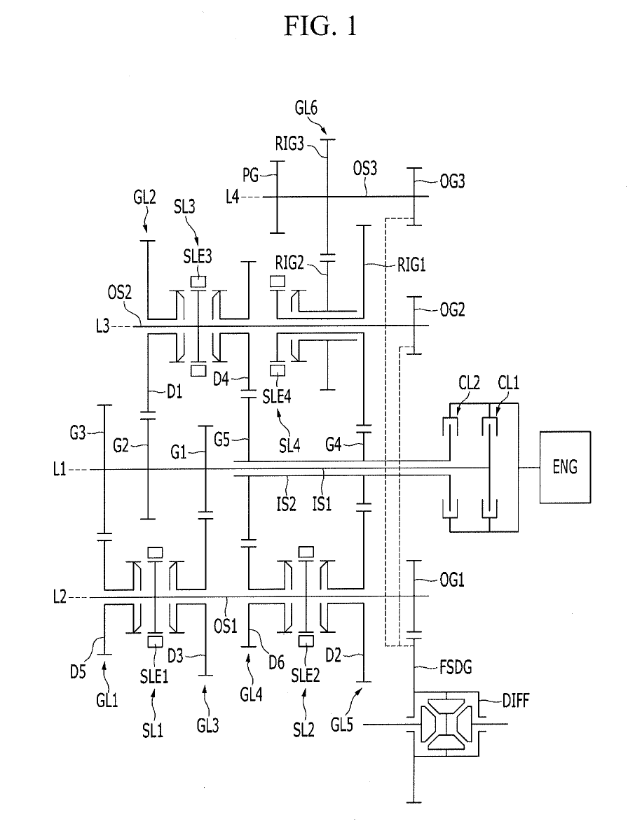

FIG. 1 is a schematic diagram of a power transmission apparatus configured for a vehicle according to an exemplary embodiment of the present invention.

referring to FIG. 1, a power transmission apparatus configured for a vehicle according to an exemplary embodiment of the present invention includes first and second clutches CL1 and CL2, first and second input shafts IS1 and IS2, first and second output shafts OS1 and OS2 shifting a rotation power input through the first and second input shafts IS1 and IS2 according to each speed stage to be transmitted to a final reduction gear FSDG, and a third output shaft OS3 shifting the rotation power transmitted through the second output shaft OS2 to be transmitted to the final reduction gear FSDG.

The first and second input shafts IS1 and IS2 and the first, second, and third output shafts OS1, OS2, and OS3 are disposed on first, second, third, and fourth axes L1, L2, L3, and L4 mutually disposed in parallel at a predetermined interval.

The first and second input shafts IS1 and IS2 are disposed on the first axis L1, the first input shaft IS1 is selectively connectable to the output shaft (or a crank shaft) of the engine through the first clutch CL1, the second input shaft IS2 includes a hollow shaft, is disposed on an external circumference side of the first input shaft IS1 without an interference, and is selectively connectable to the output shaft (or the crank shaft) through the second clutch CL2.

The first and second clutches CL1 and CL2 are engagement elements and mainly utilize a wet multi-plate type hydraulic pressure friction engagement device as a hydraulic pressure friction engagement device which is operated by hydraulic pressure supplied from a hydraulic pressure control apparatus, but it may include the engagement device which may be operated depending an electrical signal supplied from an electric control apparatus such as a dog clutch, a differential clutch, an electronic clutch, etc.

First, second, and third input gears G1, G2, and G3 are disposed to be separated from each other on the first input shaft IS1. The first, second, and third input gears G1, G2, and G3 are fixedly disposed on a rear side portion of the first input shaft IS1 penetrating the second input shaft IS2 and are disposed in order of the first, second, and third input gears G1, G2, and G3 from a front side to a rear side thereof.

Fourth and fifth input gears G4 and G5 are disposed to be separated from each other on the second input shaft IS2. The fourth and fifth input gears G4 and G5 are disposed in order of the fourth and fifth input gears G4 and G5 from the front side to the rear side thereof. The fourth and fifth input gears G4 and G5 are fixedly disposed on the second input shaft IS2.

If the first clutch CL1 is operated, the first, second, and third input gears G1, G2, and G3 are rotated while the first input shaft IS1 is rotated, and if the second clutch CL2 is operated, the fourth and fifth input gears G4 and G5 are rotated while the second input shaft IS2 is rotated.

The first output shaft OS1 is disposed on the second axis L2. The first output shaft OS1 outputs the rotation power transmitted through two paths from the first input shaft IS1 and the rotation power transmitted through two paths from the second input shaft IS2 to a final reduction gear FSDG of a differential apparatus DIFF through the first output gear OG1.

The second output shaft OS2 is disposed on the third axis L3. The second output shaft OS2 outputs the rotation power transmitted through one paths from the first input shaft IS1 and the rotation power transmitted through one paths from the second input shaft IS2 to the final reduction gear FSDG of the differential apparatus DIFF through the second output gear OG2.

The third output shaft OS3 is disposed on the fourth axis L4. The third output shaft OS3 outputs the rotation power transmitted from the second input shaft IS2 through a plurality of reverse idle gears rotatably disposed on the second output shaft OS2 to the final reduction gear FSDG of the differential apparatus DIFF through the third output gear OG3.

Here, “a gear is fixedly disposed on a shaft” means that a corresponding gear is always rotated in the same direction with the same rotation speed as a corresponding shaft. Also, “a gear is rotatably disposed on a shaft” means that a corresponding gear is relatively rotated with a corresponding shaft.

The first and second input shafts IS1 and IS2 are operationally connected to the first, second, and third output shafts OS1, OS2, and OS3 through first, second, third, fourth, fifth, and sixth speed stage gear sets GL1, GL2, GL3, GL4, GL5, and GL6.

The first speed stage gear set GL1 includes a third input gear G3 fixedly disposed on the first input shaft IS1 and a fifth speed gear D5 rotatably disposed on the first output shaft OS1 and meshed with the third input gear G3.

The second speed stage gear set GL2 includes a second input gear G2 fixedly disposed on the first input shaft IS1 and a first speed gear D1 rotatably disposed on the second output shaft OS2 and meshed with the second input gear G2.

The third speed stage gear set GL3 includes a first input gear G1 fixedly disposed on the first input shaft IS1 and a third speed gear D3 rotatably disposed on the first output shaft OS1 and meshed with the first input gear G1.

The fourth speed stage gear set GL4 includes a fifth input gear G5 fixedly disposed on the second input shaft IS2, a sixth speed gear D6 rotatably disposed on the first output shaft OS1 and meshed with the fifth input gear G5, and a fourth speed gear D4 rotatably disposed on the second output shaft OS2 and meshed with the fifth input gear G5.

The fifth speed stage gear set GL5 includes a fourth input gear G4 fixedly disposed on the second input shaft IS2, a second speed gear D2 rotatably disposed on the first output shaft OS1 and meshed with the fourth input gear G4, and a first reverse idle gear RIG1 rotatably disposed on the second output shaft OS2 and meshed with the fourth input gear G4.

The sixth speed stage gear set GL6 includes a second reverse idle gear RIG2 rotatably disposed on the second output shaft OS2 and selectively connectable to the first reverse idle gear of the fifth speed stage gear set GL5 and a third reverse idle gear RIG3 fixedly disposed on the third output shaft OS3 and meshed with the second reverse idle gear RIG2.

A first synchronizer SL1 is disposed between the fifth forward speed gear D5 and the third forward speed gear D3 to operationally connect the fifth speed gear D5 or the third speed gear D3 to the first output shaft OS1 selectively.

Also, a second synchronizer SL2 is disposed between the sixth forward speed gear D6 and the second forward speed gear D2 to operationally connect the sixth speed gear D6 and the second speed gear D2 to the first output shaft OS1 selectively.

Also, a third synchronizer SL3 is disposed between the first forward speed gear D1 and the fourth forward speed gear D4 to operationally connect the first speed gear D1 and the fourth speed gear D4 to the second output shaft OS2 selectively.

Also, a fourth synchronizer SL4 is disposed between the first reverse idle gear RIG1 and the second reverse idle gear RIG2 to selectively and operationally connect the first reverse idle gear RIG1 and the second reverse idle gear RIG2.

The first, second, third, fourth synchronizers SL1, SL2, SL3, and SL4 are a disclosed configuration such that a detailed description is omitted. First, second, third, fourth sleeves SLE1, SLE2, SLE3, and SLE4 applied to the first, second, third, fourth synchronizers SL1, SL2, SL3, and SL4 are operated by a separate actuator or known to a person of an ordinary skill in the art and the actuator is controlled by a transmission control device.

In FIG. 1, a reference numeral “PG” indicates a parking gear.

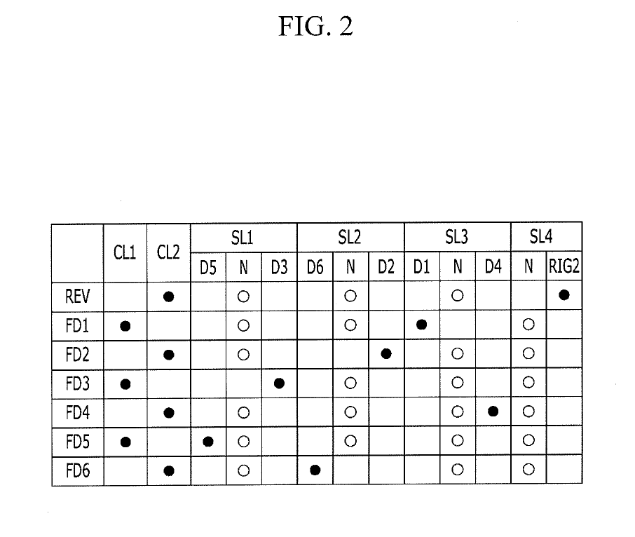

FIG. 2 is a shifting operation chart of a power transmission apparatus configured for a vehicle according to an exemplary embodiment of the present invention.

[A Reverse Speed]

In the reverse speed REV, as shown in FIG. 2, the first reverse idle gear RIG1 and the second reverse idle gear RIG2 are operationally connected through the sleeve SLE4 of the fourth synchronizer SL4 and the second clutch CL2 is operated.

Accordingly, the rotation power of the engine ENG is transmitted to the final reduction gear FSDG of the differential apparatus DIFF through the second clutch CL2, the second input shaft IS2, the fourth input gear G4, the first reverse idle gear RIG1, the second reverse idle gear RIG2, the third reverse idle gear RIG3, the third output shaft OS3, and the third output gear OG3 by the operation of the second clutch CL2. Accordingly, the vehicle may run in the reverse speed.

[A First Forward Speed]

In the first forward speed FD1, as shown in FIG. 2, the first forward speed gear D1 and the second output shaft OS2 are operationally connected through the sleeve SLE3 of the third synchronizer SL3 and the first clutch CL1 is operated.

Accordingly, the rotation power of the engine ENG is transmitted to the final reduction gear FSDG of the differential apparatus DIFF through the first clutch CL1, the first input shaft IS1, the second input gear G2, the first speed gear D1, the second output shaft OS2, and the second output gear OG2 by the operation of the first clutch CL1. Accordingly, the vehicle may run in the first forward speed.

[A Second Forward Speed]

In the second forward speed FD2, as shown in FIG. 2, the second speed gear D2 and the first output shaft OS1 are operationally connected through the sleeve SLE2 of the second synchronizer SL2 and the second clutch CL2 is operated.

Accordingly, the rotation power of the engine ENG is transmitted to the final reduction gear FSDG of the differential apparatus DIFF through the second clutch CL2, the second input shaft IS2, the fourth input gear G4, the second speed gear D2, the first output shaft OS1, and the first output gear OG1 by the operation of the second clutch CL2. Accordingly, the vehicle may run in the second forward speed.

[A Third Forward Speed]

In the third forward speed FD3, as shown in FIG. 2, the third speed gear D3 and the first output shaft OS1 are operationally connected through the sleeve SLE1 of the first synchronizer SL1 and the first clutch CL1 is operated.

Accordingly, the rotation power of the engine ENG is transmitted to the final reduction gear FSDG of the differential apparatus DIFF through the first clutch CL1, the first input shaft IS1, the first input gear G1, the third speed gear D3, the first output shaft OS1, and the first output gear OG1 by the operation of the first clutch CL1. Accordingly, the vehicle may run in the third forward speed.

[A Fourth Forward Speed]

In the fourth forward speed FD4, as shown in FIG. 2, the fourth forward speed gear D4 and the second output shaft OS2 are operationally connected through the sleeve SLE3 of the third synchronizer SL3 and the second clutch CL2 is operated.

Accordingly, the rotation power of the engine ENG is transmitted to the final reduction gear FSDG of the differential apparatus DIFF through the second clutch CL2, the second input shaft IS2, the fifth input gear G5, the fourth speed gear D4, the second output shaft OS2, and the second output gear OG2 by the operation of the second clutch CL2. Accordingly, the vehicle may run in the fourth forward speed.

[A Fifth Forward Speed]

In the fifth forward speed stage FD5, as shown in FIG. 2, the fifth speed gear D5 and the first output shaft OS1 are operationally connected through the sleeve SLE1 of the first synchronizer SL1 and the first clutch CL1 is operated.

Accordingly, the rotation power of the engine ENG is transmitted to the final reduction gear FSDG of the differential apparatus DIFF through the first clutch CL1, the first input shaft IS1, the third input gear G3, the fifth speed gear D5, the first output shaft OS1, and the first output gear OG1 by the operation of the first clutch CL1. Accordingly, the vehicle may run in the fifth forward speed.

[A Sixth Forward Speed]

In the sixth forward speed FD6, as shown in FIG. 2, the sixth forward speed gear D6 and the first output shaft OS1 are operationally connected through the sleeve SLE2 of the second synchronizer SL2 and the second clutch CL2 is operated.

Accordingly, the rotation power of the engine ENG is transmitted to the final reduction gear FSDG of the differential apparatus DIFF through the second clutch CL2, the second input shaft IS2, the fifth input gear G5, the sixth speed gear D6, the first output shaft OS1, and the first output gear OG1 by the operation of the second clutch CL2. Accordingly, the vehicle may run in the sixth forward speed.

The power transmission apparatus configured for the vehicle according to an exemplary embodiment of the present invention may realize six forward speeds and one reverse speed while reducing a number of internal configuration parts by additionally applying one synchronizer and one output shaft for the reverse speed to a conventional DCT structure. Also, the mount ability may be improved by a reduction of a vehicle length and a fuel consumption may be improved by minimizing a weight.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A power transmission apparatus for a vehicle, the power transmission apparatus comprising:
a first input shaft selectively connectable to an engine through a first clutch, wherein a first plurality of input gears is fixedly mounted on the first input shaft;
a second input shaft mounted on an external circumference side of the first input shaft without an interference therebetween and selectively connectable to the engine output shaft through a second clutch, wherein a second plurality of input gears is fixedly mounted on the second input shaft;
a first output shaft mounted to be spaced from the first and second input shafts and outputting a rotation power transmitted from the first input shaft and a rotation power transmitted from the second input shaft through a first output gear fixedly mounted to the first output shaft;
a second output shaft mounted to be spaced from the first and second input shafts and outputting a rotation power transmitted from the first input shaft and a rotation power transmitted from the second input shaft through a second output gear fixedly mounted to the second output shaft;
a third output shaft mounted to be spaced from the second output shaft and outputting a rotation power transmitted from the second input shaft through a plurality of reverse idle gears and a third output gear fixedly mounted to the third output shaft; and
six speed stage gear sets dispersed and mounted on the first and second input shafts and the first, second, and third output shafts, shifting the rotation power of the engine according to a gear ratio of predetermined fixed speed stages, and outputting the shifted rotation power through the first, second, and third output gears.

2. The power transmission apparatus for the vehicle of claim 1,
wherein the first plurality of input gears includes a first input gear, a second input gear and a third input gear;
wherein the second plurality of input gears includes a fourth input gear and a fifth input gear;
wherein the plurality of reverse idle gears includes a first reverse idle gear, a second reverse idle gear, and a third reverse idle gear; and
wherein the six speed stage gear sets include:
a first speed stage gear set including the third input gear fixedly mounted on the first input shaft and a fifth speed gear rotatably mounted on the first output shaft and engaged with the third input gear;
a second speed stage gear set including the second input gear fixedly mounted on the first input shaft and a first speed gear rotatably mounted on the second output shaft and engaged with the second input gear;
a third speed stage gear set including the first input gear fixedly mounted on the first input shaft and a third speed gear rotatably mounted on the first output shaft and engaged with the first input gear;
a fourth speed stage gear set including the fifth input gear fixedly mounted on the second input shaft, a sixth speed gear rotatably mounted on the first output shaft and engaged with the fifth input gear, and a fourth speed gear rotatably mounted on the second output shaft and engaged with the fifth input gear;
a fifth speed stage gear set including the fourth input gear fixedly mounted on the second input shaft, a second speed gear rotatably mounted on the first output shaft and engaged with the fourth input gear, and the first reverse idle gear rotatably mounted on the second output shaft and engaged with the fourth input gear; and
a sixth speed stage gear set including the second reverse idle gear rotatably mounted on the second output shaft and the third reverse idle gear fixedly mounted on the third output shaft and engaged with the second reverse idle gear.

3. The power transmission apparatus for the vehicle of claim 2, wherein the power transmission apparatus further includes:
a first synchronizer selectively connecting the fifth speed gear or the third speed gear to the first output shaft;
a second synchronizer selectively connecting the sixth speed gear or the second speed gear to the first output shaft;
a third synchronizer selectively connecting the first speed gear or the fourth speed gear to the second output shaft; and
a fourth synchronizer selectively connecting the first reverse idle gear and the second reverse idle gear.

4. The power transmission apparatus for the vehicle of claim 1, wherein the power transmission apparatus further includes a differential apparatus including a final reduction gear engaged with the first, second, and third output gears.

5. A power transmission apparatus for a vehicle, the power transmission apparatus comprising:
a first input shaft selectively connectable to an engine through a first clutch;
a second input shaft mounted on an external circumference side of the first input shaft without an interference therebetween and selectively connectable to the engine through a second clutch;
a first output shaft mounted to be spaced from the first and second input shafts and outputting a rotation power transmitted from the first and second input shafts through a first output gear fixedly mounted on the first output shaft;
a second output shaft mounted to be spaced from the first and second input shafts and outputting a rotation power transmitted from the first and second input shafts through a second output gear fixedly mounted on the second output shaft;
a third output shaft mounted to be spaced from the second output shaft and outputting a rotation power transmitted through a plurality of reverse idle gears from the second input shaft through a third output gear fixedly mounted on the third output shaft;
a first speed stage gear set including a third input gear fixedly mounted on the first input shaft and a fifth speed gear rotatably mounted on the first output shaft and engaged with the third input gear;
a second speed stage gear set including a second input gear fixedly mounted on the first input shaft and a first speed gear rotatably mounted on the second output shaft and engaged with the second input gear;
a third speed stage gear set including a first input gear fixedly mounted on the first input shaft and a third speed gear rotatably mounted on the first output shaft and engaged with the first input gear;
a fourth speed stage gear set including a fifth input gear fixedly mounted on the second input shaft, a sixth speed gear rotatably mounted on the first output shaft and engaged with the fifth input gear, and a fourth speed gear rotatably mounted on the second output shaft and engaged with the fifth input gear;
a fifth speed stage gear set including a fourth input gear fixedly mounted on the second input shaft, a second speed gear rotatably mounted on the first output shaft and engaged with the fourth input gear, and a first reverse idle gear rotatably mounted on the second output shaft and engaged with the fourth input gear; and
a sixth speed stage gear set including a second reverse idle gear rotatably mounted on the second output shaft and a third reverse idle gear fixedly mounted on the third output shaft and engaged with the second reverse idle gear.

6. The power transmission apparatus for the vehicle of claim 5, wherein the power transmission apparatus further includes:
a first synchronizer selectively connecting the fifth speed gear or the third speed gear to the first output shaft;
a second synchronizer selectively connecting the sixth speed gear or the second speed gear to the first output shaft;
a third synchronizer selectively connecting the first speed gear or the fourth speed gear to the second output shaft; and
a fourth synchronizer selectively connecting the first reverse idle gear and the second reverse idle gear.

7. The power transmission apparatus for the vehicle of claim 5, wherein the power transmission apparatus further includes a differential apparatus including a final reduction gear engaged with the first, second, and third output gears.
